(19) United States
(12) Patent Application Publication
(10) Pub. No.: US 2017/0118293 A1
(43) Pub. Date: Apr. 27, 2017

(54) METHOD AND SYSTEM FOR EFFICIENT TASK MANAGEMENT

(71) Applicant: Trilliant Networks, Inc., Redwood City, CA (US)

(72) Inventor: Philip Bridger, Sutton (CA)

(21) Appl. No.: 15/287,899

(22) Filed: Oct. 7, 2016

Related U.S. Application Data
(60) Provisional application No. 62/246,240, filed on Oct. 26, 2015.

(51) Int. Cl. H04L 29/08; H04L 29/06

(52) U.S. Cl. CPC H04L 67/14; H04L 67/42; H04L 67/10

(57) ABSTRACT

A computer implemented method and apparatus for efficient task management. The method comprises receiving a task request on a first server of a plurality of server, wherein a task associated with the task request is to be performed on a first device of a plurality of devices; determining an identification of a second server of the plurality of servers that has an affinity for the requested task, wherein the second server is different from the first server; and transferring the task request to the second server.

### CROSS-REFERENCE TO RELATED APPLICATIONS

This application claims priority to U.S. Provisional Patent Application Ser. No. 62/246,240 filed Oct. 26, 2015, which is incorporated by reference herein in its entirety.

### BACKGROUND OF THE INVENTION

Field of the Invention

Embodiments of the present invention generally relate to task management, and more specifically to power meter monitoring and control.

Description of the Related Art

Energy management requires a significant amount of interaction with devices, such as smart meters in order to perform meter reads, firmware updates, and the like. Customers, such as energy providers (e.g., an electric utility) request information from the devices via a task management service. Opening a communication channel to a device is costly in terms of time and resources. In addition, devices are limited in a number of communication channels that may be open at a given time.

For example, a first request may be received from an energy provider on server1, requesting a meter read of deviceA for a specified period of time. At the same time, a second request may be received from a development group on server2, requesting a firmware upgrade of deviceA. In order to meet these requests, server1 opens a communication channel to deviceA and executes the meter read, while server2 opens a communication channel to deviceA for the firmware upgrade. Opening a communication channel is costly in terms of time and money. In addition, the limitations of deviceA may only allow one communication channel open at a given time. As such, in addition to the cost of opening two communication channels, due to the limitations of the device, one of the requests may fail.

Therefore, there is a need for a method and apparatus for efficient task management.

### SUMMARY OF THE INVENTION

An apparatus and/or method is provided for efficient task management substantially as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a block diagram of a system for efficient task management, according to one or more embodiments of the invention;

FIG. 2 depicts a flow diagram of a method for efficient task management, according to one or more embodiments of the invention; and

FIG. 3 depicts a computer system that can be utilized in various embodiments of the present invention to implement the computer and/or the display, according to one or more embodiments of the invention.

While the method and apparatus is described herein by way of example for several embodiments and illustrative drawings, those skilled in the art will recognize that the method and apparatus for efficient task management is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for efficient task management defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for a system and method for efficient task management, resulting in fewer communication channels being opened when interfacing with a device (e.g., a meter). A task request is received on a first server. The received task may be any task that requires communication with a device. For example, where the device is a meter, tasks may include a meter read, a firmware upgrade, and the like. For example, the received task request may be “Get meter read from deviceABC for the time period X.” The received task is to be executed on a specific device. A task manager determines on which device the task is to be executed, in the present example, deviceABC. The task manager requests from the device driver associated with the device which server currently has a communication channel open to the device on which the task is to be executed. If the first server on which the request was received has a communication channel open to the device, a device driver for said device on the first server executes the task. However, if the device driver determines that a second server has a communication channel open to the device, the task manager sends the task to the second server. A task manager on the second server performs the same steps to determine where a communication channel is open to the device. If the communication channel is still open on the second server, the device driver for the device executes the task. If the communication channel has since closed, the device driver determines on which server a communication channel is now open and the task manager on the second server forwards the request to the determined server for execution. The server may be a third server, or it may be the first server if a communication channel to the device has been opened on the first server. However, if there is not a communications channel open to the requested device from any server, the communication channel is opened on the server that received the request.

As used herein, a task may have an “affinity” for a given task manager. The affinity defines a task manager where the task should be run. As described above, a task may have an affinity for the task manager that last executed a task toward a given device. In some embodiments, a task may have an affinity to a given task manager based on the specific type of task to be executed or a specific connection. For example, a task that runs for a long period of time, such as a firmware upgrade may have an affinity for a specific task manager to execute the firmware upgrade. In such embodiments, the task defines the task manager for which it has an “affinity”, such that the task is run on the defined task manager.

Various embodiments of a method and apparatus for efficient task management are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. Although the present application is described using a JAVA environment, for example, a Java Messaging Service (JMS) bus, a Java Virtual Machine (JVM), and the like, one skilled in the art will appreciate that any program language protocols may be used to perform the disclosed invention. Although the present application describes the invention using task management servers connected to smart meters, one skilled in the art will appreciate that any the present invention may be implemented on specific or general purpose computers (e.g., cloud servers) that communicate with devices.

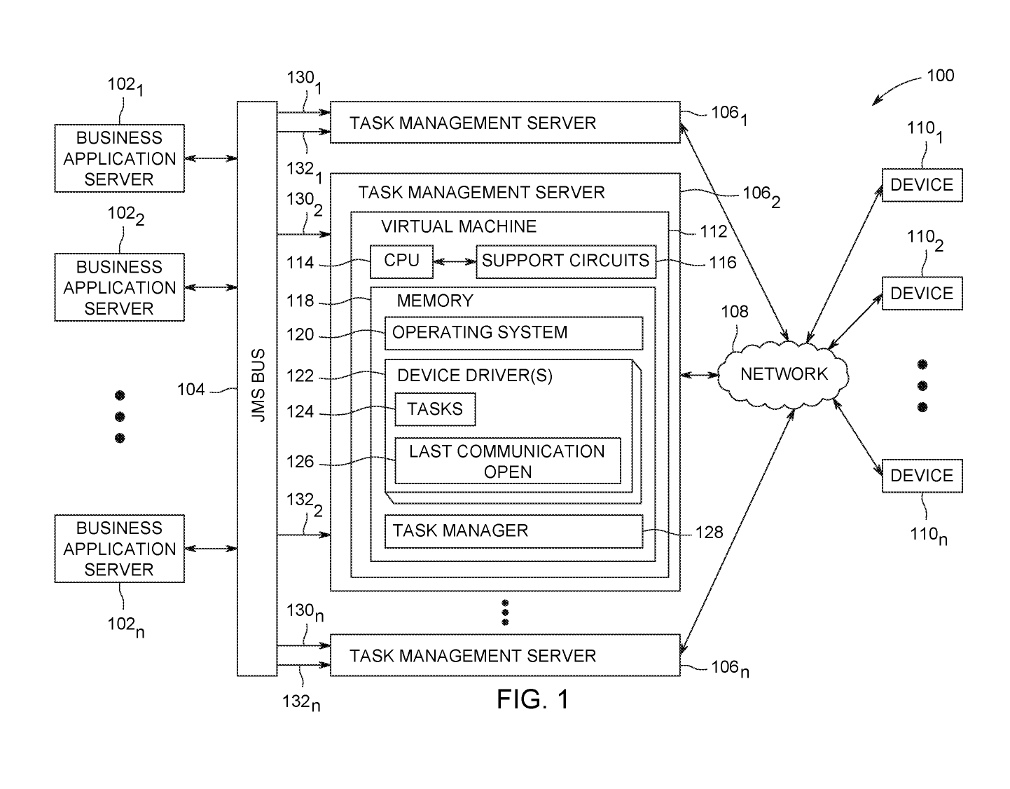

FIG. 1 depicts a block diagram of a system 100 for efficient task management, according to one or more embodiments of the invention.

The system 100 includes a plurality business servers 102₁, 102₂, . . . 102ₙ (collectively referred to herein as business servers 102). The business servers 102 submit requests via a message routing server, such as JMS bus 104. The JMS bus 104 provides messages to a plurality of task management servers 106₁, 106₂, . . . 106ₙ (collectively referred to herein as task management servers 106) via generic queue 130₁, 130₂, . . . 130ₙ (collectively referred to herein a generic queue 130). The task management servers 106 receive the requests submitted by the business servers 102 and execute each request towards at least one of a plurality of devices 110₁, 110₂, . . . , 110ₙ (collectively referred to herein as devices 110). The devices 110 are communicatively coupled to the task management servers 106 via network 108. In some embodiments, each of the plurality of devices 110₁, 110₂, . . . , 110ₙ is a smart meter.

In some embodiments, the task management servers 106 are a plurality of physical machines. In some embodiments, each of the task management servers 106 may include one or more virtual machines 112, such as a JAVA Virtual Machine (JVM). Each of the task management servers 106, or in the case where a server 106 includes one or more virtual machines 112, each virtual machine 112, includes a Central Processing Unit (CPU) 114, support circuits 116, and a memory 118. The CPU 114 may include one or more commercially available microprocessors or microcontrollers that facilitate data processing and storage. The various support circuits 116 facilitate the operation of the CPU 114 and include one or more clock circuits, power supplies, cache, input/output circuits, and the like. The memory 118 includes at least one of Read Only Memory (ROM), Random Access Memory (RAM), disk drive storage, optical storage, removable storage and/or the like.

The memory 118 includes an operating system 120, a plurality of device drivers 122, and a task manager 128. The operating system 120 may include various commercially known operating systems. Each of the plurality of device drivers 122 includes one or more tasks 124 that may be executed on a device 110 and an indication of a server 106 on which a last communication was open 126 to the device 110. The number of device drivers 122 on a server 106 is equal to the number of devices 110 such that tasks may be sent in parallel to multiple different devices. There is a one-to-one correspondence between a device driver 122 and a device 110 on each server 106.

The network 108 includes a communication system that connects computers (or devices) by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, and the like.

When a business application requires information regarding a device 110, for example, when the business application needs to read an energy profile for a given timeframe, the business application server 102 submits a request on the JMS bus 104. In some embodiments, the JMS bus 104 submits the request to a first available task management server 106. In some embodiments, the JMS bus 104 thereafter submits requests to task management servers 106 in a round-robin manner. In some embodiments, the round robin order is based on the order in which the task management servers 106 connected to the JMS bus 104. The JMS bus 104 submits the request on a generic queue 130. The server 106₁ extracts the request from the generic queue 130. For example, the request may be for a meter read from the meter with serial number 123 for the timeframe of 8 am-10 am. The task manager 128 determines to which device 110 the request is to be executed. The task manager 128 requests from the device driver 122 associated with the device 110 an indication of which server 106 has an affinity to (i.e., already has a connection open to) the device 110. In some embodiments, the device driver 122 retrieves the server 106 from which the last task performed on the device 110 was executed. The device driver 122 accesses a shared memory (not shown). The shared memory may be a remote server accessible by all task management servers 106. Within the shared memory is a stored first association between each device 110 and each task manager 128. The association identifies which task manager 128 on which server 106 was the last task manager 128 to execute a task toward the identified device 110. There also exists a secondary association between tasks 124 and task manager 128 on a given task management server 106. The secondary association enables the execution of a task 124 to a device 110 by a specific task manager 128. The secondary association also enables the execution of a task 124 on a task manager 128.

If the device driver 122 determines, from the shared memory that the last task performed on a device was executed from a device driver 122 on the current server (e.g., task management server 106₁) where the request was received, the task manager 128 generates a task for the device driver 122 associated with the device 110 to which the task is to be executed. The device driver 122 then executes the task toward device 110. However, if the device driver 122 determines from the shared memory that the last task performed on device 110 was executed on a different server 106, for example, server 106₂, the task manager 128 generates a request and sends it back to the JMS bus 104 on a named queue 132, where the named queue 132 identifies the specific server 106 on which a connection to the device 110 is determined to be open.

The server 106₂ extracts the request from the named queue. However, when the server 106₂ receives the request, the connection to the device 110 may have been lost in the time it took to receive the request and the connection opened on another server 106. As such, server 106₂ repeats the steps that were performed on server 106₁. If the connection is determined to be open on the current server 106₂, the task is executed by device driver 122 on server 106₂. If the connection has been lost and the device driver 122 identifies a different server 106 on which a communication channel is open, the task manager 128 on server 106₂ generates a request and sends it back to the JMS bus 104 on a named queue 132 for the identified server 106 where the connection is open.

In embodiments where a task management server 106 includes one or more VMs 112, a task may be sent from a first VM 112 to a second VM 112 on a same server 106.

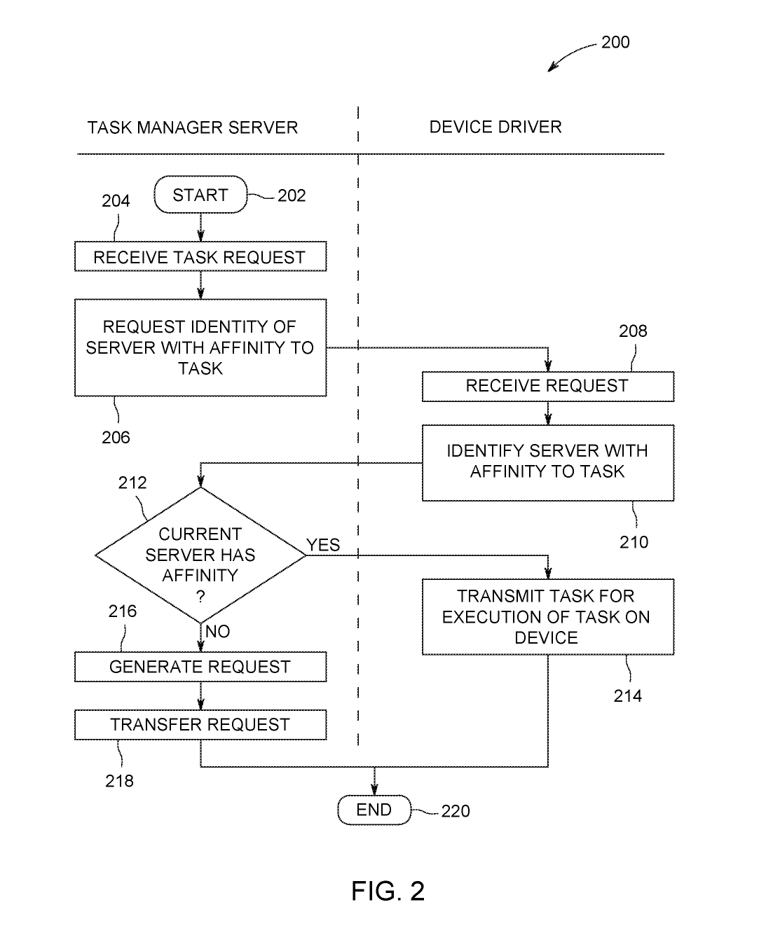

FIG. 2 depicts a flow diagram of a method 200 for efficient task management, according to one or more embodiments of the invention. The method 200 starts at step 202 and proceeds to step 204.

At step 204, a request is received. The request may be from a business application server 102. The request identifies what task is to be performed on which device 110. For example, the request may be to perform a firmware upgrade on a smart meter with serial number 123.

At step 206, a task manager 128 requests the identity of the server where the communication channel to the device was last open. The task manager determines from the request, on which device 110 the task is to be performed. In the present example, the device is meter 123. The task manager sends a request to a memory shared by all task management servers, requesting on which server the last communication channel was opened.

At step 208, the device driver receives the request from the task manager. At step 210, the device driver identifies on which server a communication is open to the device and sends the identity of the server to the task manager. The device driver retrieves the server (or VM) from where a most recent previous task was executed.

At step 212, it is determined whether a communication channel is open to the device from the current server (or current VM) where the request was received. If it is determined that the communication channel is open from the current server (or VM) to the device, then at step 214, the a task is generated and sent to the device driver, which in turn transmits the task for execution on the device. The task manager also updates the shared memory to identify itself (and the task management server) as the last task manager 128 to have an open communication channel to the device. The method 200 ends at step 220.

However, if at step 212, it is determined that a communication channel is not open to the device from the current server (or current VM) where the request was received, then at step 216, a new request is generated.

At step 218, the task manager transfers the request to a JMS bus on a queue identified for the server (or VM) where a communication channel is determined to be open and the method 200 ends at step 220. The steps of method 200 are repeated on the server where the task is transferred to until the task is received on the server where there is a communication channel open and the task is sent for execution on the device. The task manager also updates the shared memory to identify itself (and the task management server) as the last task manager 128 to have an open communication channel to the device and the method 200 ends at step 220.

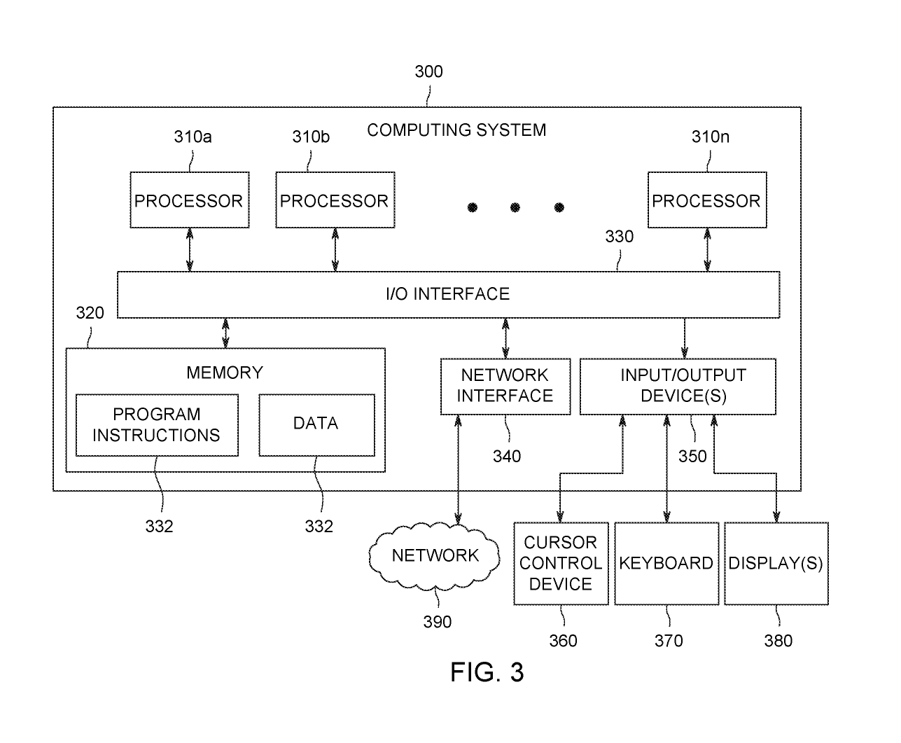

FIG. 3 depicts a computer system 300 that can be utilized in various embodiments of the present invention to implement the computer and/or the display, according to one or more embodiments.

Various embodiments of method and apparatus for efficient task management, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement the method 200 as processor-executable executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the operations and methods described above, such as the operations described with respect to FIG. 1 and the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for efficient task management comprising:
receiving a task request on a first server of a plurality of server, wherein a task associated with the task request is to be performed on a first device of a plurality of devices;
determining an identification of a second server of the plurality of servers that has an affinity for the requested task, wherein the second server is different from the first server; and
transferring the task request to the second server.

2. The method of claim 1, further comprising:
receiving the task request on the second server, wherein a task associated with the task request is to be performed on the first device;
determining the second server no longer has an affinity for the requested task;
determining an identification of a third server of the plurality of servers that has an affinity for the requested task, wherein the third server is different from the second server; and
transferring the task request to the third server.

3. The method of claim 1, wherein transferring the task request comprises sending the task request to a named queue for the second server.

4. The method of claim 1, wherein determining the identification of a second server of the plurality of servers that has an affinity for the requested task comprises:
transmitting a request to a shared memory; and
receiving in response to the request an indication of which server of the plurality of servers has an affinity for the task associated with the task request.

5. The method of claim 1, wherein the second server has an affinity for the requested task when it is determined the second server is the server in the plurality of servers where a communication channel to the first device was last opened.

6. The method of claim 1, wherein the second server has an affinity for the requested task when the second server is predefined to execute a specific type of task associated with the task request.

7. The method of claim 1, further comprising, upon determining that the server with an affinity for the requested task is a current server where the task request was received, performing the steps of:
generating a task based on the task request; and
providing the generated task to a device driver for the first device, wherein providing the generated task causes the device driver to transmit the generated task to the first device for execution.

8. The method of claim 7, further comprising storing in a shared memory an indication of which server of the plurality of servers generated the task and provided the generated task to the device driver for the first device.

9. The method of claim 1, wherein the first server and the second server are virtual machines on a same server.

10. A system for efficient task management for a plurality of task management servers, comprising:
a) at least one processor;
b) at least one input device; and
c) at least one storage device storing processor-executable instructions which, when executed by the at least one processor, perform a method including:
receiving a task request on a first server of a plurality of server, wherein a task associated with the task request is to be performed on a first device of a plurality of devices;
determining an identification of a second server of the plurality of servers that has an affinity for the requested task, wherein the second server is different from the first server; and
transferring the task request to the second server.

11. The system of claim 10, further comprising:
receiving the task request on the second server, wherein a task associated with the task request is to be performed on the first device;
determining the second server no longer has an affinity for the requested task;
determining an identification of a third server of the plurality of servers that has an affinity for the requested task, wherein the third server is different from the second server; and
transferring the task request to the third server.

12. The system of claim 10, wherein transferring the task request comprises sending the task request to a named queue for the second server.

13. The system of claim 10, wherein determining the identification of a second server of the plurality of servers that has an affinity for the requested task comprises:
transmitting a request to a shared memory; and
receiving in response to the request an indication of which server of the plurality of servers has an affinity for the task associated with the task request.

14. The system of claim 10, wherein the second server has an affinity for the requested task when it is determined the second server is the server in the plurality of servers where a communication channel to the first device was last opened.

15. The system of claim 10, wherein the second server has an affinity for the requested task when the second server is predefined to execute a specific type of task associated with the task request.

16. The system of claim 10, further comprising, upon determining that the server with an affinity for the requested task is a current server where the task request was received, performing the steps of:
generating a task based on the task request; and
providing the generated task to a device driver for the first device, wherein providing the generated task causes the device driver to transmit the generated task to the first device for execution.

17. The system of claim 16, further comprising storing in a shared memory an indication of which server of the plurality of servers generated the task and provided the generated task to the device driver for the first device.

18. The system of claim 10, wherein the first server and the second server are virtual machines on a same server.

19. A non-transitory computer readable medium for storing computer instructions that, when executed by at least one processor causes the at least one processor to perform a method for efficient task management, comprising:
receiving a task request on a first server of a plurality of server, wherein a task associated with the task request is to be performed on a first device of a plurality of devices;
determining an identification of a second server of the plurality of servers that has an affinity for the requested task, wherein the second server is different from the first server; and
transferring the task request to the second server.

20. The non-transitory computer readable medium of claim 19, further comprising:
receiving the task request on the second server, wherein a task associated with the task request is to be performed on the first device;
determining the second server no longer has an affinity for the requested task;
determining an identification of a third server of the plurality of servers that has an affinity for the requested task, wherein the third server is different from the second server; and
transferring the task request to the third server.
